(19) United States
(12) Patent Application Publication
(10) Pub. No.: US 2003/0012700 A1
(43) Pub. Date: Jan. 16, 2003

(54) Systems and methods for parallel testing of catalyst performance

(76) Inventor: James Claude Carnahan, Niskayuna, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,025

(22) Filed: Jul. 11, 2001

(51) Int. Cl. B01J 19/00

(52) U.S. Cl. 422/102; 422/130; 436/174

(57) ABSTRACT

This invention relates to a continuous flow chemical reaction system, and methods for use thereof, in which a plurality of passive flow controllers are used for receiving a feed gas having predetermined characteristics and for outputting a feed gas at a selected flow rate into a plurality of reactor tubes operatively connected in parallel, each of which is operable for containing a predetermined reactant capable of interacting with the feed gas in a predetermined reaction to produce a resulting effluent; and an analytical device connectable to the reactor tubes for receiving the respective resulting effluents and for generating a relative evaluation of each predetermined reaction.

### BACKGROUND OF INVENTION

This invention relates to apparatus and methods for the economical and efficient evaluation of chemical reactions within a parallel reaction vessel system.

The evaluation of heterogeneous catalysis for industrial or automotive applications has traditionally been performed in single tube reactors and the evolved products analyzed in real-time or collected and analyzed at a later time. This is slow and cumbersome and does not permit comparison of multiple catalysts under cycling process conditions that can lead to the loss of catalyst performance. The use of many single reactors run simultaneously does not offer infrastructure cost benefits (gas and heat controls, monitoring systems, analytical capabilities) and can suffer from variations in composition and condition that may reduce the comparability of the results.

Historically, the typical method of analyzing a catalyst is to prepare the catalyst in the laboratory, place it into a tubular reactor, add the conversion material, reagent, or waste product, and then monitor over time the composition of the exhaust gases or the effluent from the reactor, as well as other parameters such as back pressure and temperature of the bed. In some cases, other substances might be introduced to the catalyst bed to enhance or accelerate the aging process.

Other components of the aging process are the thermal and chemical changes that occur when a catalyst is temperature or rate cycled. For example, a catalyst may be cycled through either inadvertent or purposeful power or feed stock interruptions. An example of a purposeful interruption or change in process is in a gas conversion catalyst for fuel cells, where methane or another hydrocarbon source is converted into hydrogen which is used, in turn, to fuel a fuel cell to produce electricity. In that case, demand drives the operation of the catalytic system and, therefore, the operating conditions of the reactor will vary with the electrical demand. It is known in the art that changes in operating condition of reactors can lead to changes in catalyst performance over the long-term, because of such effects as thermal cracking, thermal shock-induced fragmentation of the beds, changes in the particle sizes as a result of those thermal changes and/or migration of catalyst species, or in the process of sintering. Among other activities that can change catalyst performance over a period of time is the migration of support materials or deposition of trace impurities in feed streams to cover or occlude the catalyst-active species.

What is needed, then, are devices and methods to allow the simultaneous evaluation of either a single catalyst or several catalysts with the addition of a reagent or reagents. What is further needed is the ability to compare catalyst performance in the face of condition cycling, with constant or variable feed stock flow and/or temperature conditions.

### SUMMARY OF INVENTION

The present invention provides a parallel reaction system in which chemical reactions may be efficiently and economically evaluated. The parallel design of the inventive systems allows for evaluation of multiple simultaneous reactions, resulting in a more efficient and accurate analysis of the experimental results.

More specifically, the present invention is directed to a continuous flow chemical reaction system, and methods for use thereof, in which a plurality of flow controllers are used for receiving a feed gas having predetermined characteristics and for outputting a common feed gas at a desired flow rate into a plurality of reactor tubes operatively connected in parallel, each of which is operable for containing a predetermined reactant capable of interacting with the feed gas in a predetermined reaction to produce a resulting effluent; and an analytical device connectable to the reactor tubes for receiving the respective resulting effluents and for generating a relative evaluation of each predetermined reaction.

Further aspects and advantages of the present invention will be more clearly apparent to those skilled in the art during the course of the following description, references being made to the accompanying drawings which illustrate some preferred forms of the present invention and wherein like characters of reference designate like parts throughout the drawings.

### BRIEF DESCRIPTION OF DRAWINGS

FIG. 1 is a schematic diagram showing the elements of one exemplary embodiment of the present invention; and

FIG. 2 is a schematic diagram showing the elements of another exemplary embodiment of the present invention.

### DETAILED DESCRIPTION

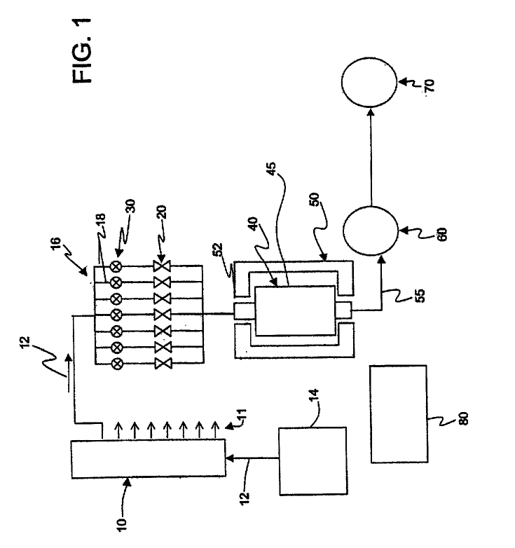

For the purposes of promoting an understanding of the principles of the invention, references will now be made to some of the preferred embodiments of the present invention as illustrated in FIGS. 1 through 3, and specific language used to describe the same. It will nevertheless be understood that no limitation of the scope of the invention is thereby intended. The terminology used herein is for the purpose of description and not limitation. Any modifications or variations in the depicted method or device, and such further applications of the principles of the invention as illustrated therein, as would normally occur to one skilled in the art, are considered to be within the spirit of this invention. For instance, features illustrated or described as part of one embodiment can be used on another embodiment to yield a still further embodiment. Thus, it is intended that the present invention cover such modifications and variations as come within the scope of the appended claims and their equivalents.

The present invention includes apparatus and methods for accelerating the testing of catalyst performance in heterogeneous gas phase reactions. An exemplary embodiment of one flow channel of the present invention is shown in a schematic form in FIG. 1. A manifold 10 with a plurality of parallel channels 11 delivers a reactant feed gas mixture 12, from a gas source 14, through a flow controller 16 associated with a single reactor tube 40. The flow controller 16 includes a plurality of parallel channels 18 each having passive flow control devices 20 serially connected with externally switchable valves 30 that flow into the single reactor tube 40, which may be surrounded by and in thermal communication with a temperature controlled heater jacket 50. The feed gas 14, having predetermined flow conditions dictated by predetermined settings of the flow controller 16, interacts with reactants 45 within the reactor tube 40 and the resulting reaction effluent 55 is directed out of the reaction tube. A multiport stream sampling valve 60 selectively receives the reaction effluent 55 and isolates samples that are then analyzed using commercially available analytical devices 70 such as, but not limited to, gas chromatography devices, infrared spectrometry, mass spectrometry devices, UV absorbance, Raman spectroscopy devices or specific gas sensors.

One feature of this embodiment of the present invention is the passive flow controllers 20, which provide for flow control and flow variability to each individual reactor tube 40. The plurality of passive flow controllers 20 associated with each reactor tube 40 may have different flow capacities, such that in combination with the turning off and on of variable combinations of parallel channels 78 by the switchable valves 30, a wide range of predetermined flow rates of the feed gas 74 may be provided to the reactor tube. The passive flow control devices 20 can be capillary tubes, critical orifices, needle valves or other non-active means of limiting flow based on upstream pressure. Preferentially, the passive flow control would be through the use of critical orifice controller so that variations in downstream pressure do not vary the reactor flow rates.

In operation, the passive flow controllers 20 would be chosen to reflect the extremes of flow requirements. Most simply, a single channel of controlled flow could be employed in the most basic embodiment of the present invention. Alternately, preferred embodiments of the present invention, however, would likely involve a plurality of such passive flow controllers 20 having flow rates that can be added beneficially to generate step gradients in flow. For example, seven such controllers with limiting relative flow rates of about 1, 2, 4, 8, 16, 32, and 64 flow units would give composite values of flow capability in a range of about 1:127, along with allowing zero flow. Other benefits of using passive flow control devices 20 are that the devices would not have temperature limitations of regulators or mass flow controllers and could be used with vaporized liquid feeds if the gas feed system was kept heated.

Another element of the present invention reflected in the exemplary embodiment is the provision for a multiple reactor tube device with a single common composition feed gas. Although only a single reactor tube 40 is shown in FIG. 1, a combinatorial system may include a plurality of reactor tubes each having an associated flow controller, with each flow controller coupled to one channel associated with the manifold. Additionally, the invention provides modular individual reactor tubes, which are isolable from the overall system to permit catalyst replacement without disturbing the flow through the remaining reactor tubes.

Yet another element of the present invention reflected in the exemplary embodiment is the provision to allow pre-heating of the feed gas in the system to reflect true operating conditions in industrial or automotive applications. For example, a preheating device 52 may be in thermal communication with all or a portion of the flow channel that extends between the flow controller 16 and the reaction tube 40. The preheating device 52 is a temperature-controlled device that allows the feed gas 14 entering the reactor tube 40 to be maintained at a predetermined temperature. The predetermined temperature may vary depending on the particular reaction, or the predetermined temperature may vary during the reaction.

An additional element of the present invention in the exemplary embodiment shown is the passage of effluents 55 from the reactor tubes 40 to the analytical instrumentation 70 in a continuous flow through a multiple port-sampling valve 60. The multiport sampling valve 60 may be connected to any one of the reactor tubes 40, thereby allowing selective sampling of all the reactor tubes. This provision allows serial quantitative and/or qualitative sampling of any selected individual reactor tube.

The gas source 14 may include a plurality of gases that may be introduced to the manifold 10 individually or in combination. The types of gases provided by gas source 14 may vary depending on the desired reaction. Suitable examples of appropriate gases include, but are not limited to, hydrocarbons, aromatics, refined petroleum products, and reducing and oxidizing gases. Specifically, hydrogen, methane, acetylene, ethene, ethane propyne, propene, propane, and higher acetyleneic, unsaturated or saturated hydrocarbons. Inert diluents may include helium, nitrogen, and argon. Other reactive gases such as steam, carbon dioxide, carbon monoxide, oxygen, nitrogen oxides, sulfur oxides, ammonia, may also be useful in evaluation of catalyst performance. Specific chemical reactions, such as the reaction of methyl chloride with silicon metal to produce methylchlorosilanes or the reaction of methanol with phenol to produce cresol and xylenol are non-limiting examples of specific reactions. Mixtures of gases representing practical feed streams such as exhaust streams from automotive gasoline engine, diesel engine, gas turbine or other combustion system effluents, with or without admixture with reactive additives are also useful in evaluation of pollution control catalysts. Feed streams containing hydrocarbons such as methane, propane, gasoline, diesel fuel, jet fuel and other liquid fuels along with steam and an oxidant such as air may be used to evaluate reformer catalysts for production of hydrogen for fuel cells.

The manifold 10 may be any device that has an input for receiving the feed gas 14 and a plurality of outputs for distributing the feed gas to a plurality of reaction tubes 40. Preferably, the manifold 10 is constructed such that the feed gas 14 delivered to each of the plurality of channels 11 has substantially equivalent characteristics, such as the temperature pressure and composition.

The reaction tube 40 may be an open-ended, cylindrical structure manufactured from a material that does not interact with the desired reaction. For example, the reaction tube 40 may be constructed from materials such as glass, quartz, metals, metals with inert coatings on their inner walls, or non-porous ceramic materials. The reaction tube 40 may further include a reaction bed, such as a porous material that supports the reactants 45 and that allows the flow through of feed gas 14 and the resulting effluent 55. For example, the reaction bed may be a screen like metal material or a fritted metal or vitreous material. The reaction bed support may also be a post or other fixture suitable for retaining a monolith catalyst in proper position. This device would be constructed to not obscure the gas flow channels in the monolith.

The reactants 45 may include catalyst that interacts with the feed gas 14 to produce a reaction product or effluent 55. The reactants 45 may include any material through which the feed gas 14 may flow, such as solid materials. The composition and quantity or volume of the reactants 45 may vary with the desired reaction, and may vary from reactor tube to reactor tube in a combinatorial experiment. Suitable examples of reactants 45, include but are not limited to, supported precious metal catalysts, (Pt, Pd, Rh), transition metal catalysts containing metals or compounds such as cobalt, chromate, or vanadate catalysts.

The heater device 50 may comprise one or more thermally controllable devices in thermal communication with a reactor tubes 40. For example, the heater device 50 may include a heating/cooling block, a tube furnace, wrapped tape heating elements, or heating baths of gas, liquids or molten salts or metals. The reactor tubes may be enclosed in a common heater to provide common temperature for all reactors or the individual reactors or groups of reactors may be contained in separately controlled heater devices. The separately controlled heater devices are a preferred embodiment since this permits a range of operating conditions as well as safe removal of individual tubes without disturbing longer-term reactions in other tubes.

The analytical device 70 can be selected from such devices as specific gas monitors, mass spectrometers, gas chromatographs or infrared, UV, visible Raman, near IR spectrometers and specific component sensors. The analytical device 70 may be connected to each reactor tube. Alternatively, samples of effluent 55, The feed to the analytical technology, can be through full by-pass stream sampling valves such as a multiple-port-continuous flow stream sampling valve such as the commercially-available valve made by VICI™. This allows non-sampled paths to flow through the valve so that there is no interruption in reactor flows while serially sampling individual reactor effluents.

Additionally, a system controller 80 may be in communication with each element of the system to monitor and control the operations of the system. For example, the system controller 80 may include a processor, a memory, inputs/outputs, and visual displays, as well as the appropriate hardware and software for storing, processing and analyzing information associated with each reactor tube, the reaction conditions, and the resulting reaction product effluent. Alternately, the system components may be manually controlled.

An example of an application for the present invention would be cycling flow over a test catalyst from low flow to high flow with known dwell times at the low and high flow states. This might mimic start-up and shutdown conditions of a continuous flow process where coking and other catalyst defects may occur. The temperature of the reaction tube can be kept constant during the flow variations or the reaction tube temperature can be varied to present different thermal conditions at the high and low flow states. Because of the pressure control on the manifold, changes in individual reactor feed rates will not influence the flow in other reactor tubes connected to the manifold and individual tubes may be shut off and catalysts changed without interrupting testing on other reactors in the system.

This invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein, may suggest themselves to those skilled in the art without departing from the spirit of the present invention.

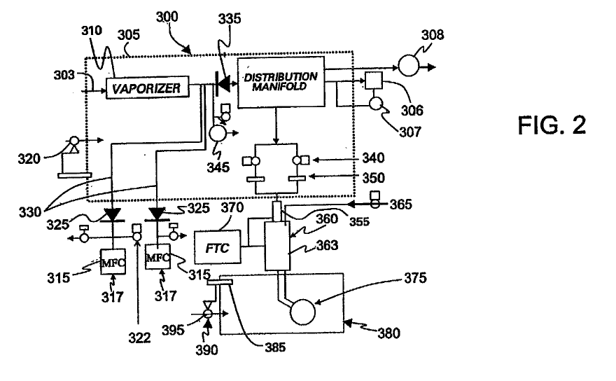

FIG. 2 shows a schematic diagram of another embodiment of a system 300 for the parallel testing of catalyst performance. The system 300 includes a gas supply, safety equipment, and furnace/analysis systems. This exemplary embodiment is specific to the reformer technology, which is the reaction of methane air and steam to produce hydrogen. It should be noted, however, that other reactions may be performed in this system or other similar systems. For example, reactions such as the reaction of methyl chloride with silicon metal to produce methylchlorosilanes or the reaction of methanol with phenol to produce cresol and xylenol are non-limiting examples of specific reactions. Mixtures of gases representing practical feed streams such as exhaust streams from automotive gasoline engine, diesel engine, gas turbine or other combustion system effluents, with or without admixture with reactive additives are also useful in evaluation of pollution control catalysts. Feed streams containing hydrocarbons such as methane, propane, gasoline, diesel fuel, jet fuel and other liquid fuels along with steam and an oxidant such as air may be used to evaluate reformer catalysts for production of hydrogen for fuel cells. Other reactions include oxidation of methanol to formaldehyde, catalytic conversion of methanol to hydrocarbon fuels., hydrogenation of unsaturated organics, alkylation of phenols, oxidation of aromatics or alkyl aromatics to produce phenols or carboxylic acids or anhydrides.

In system 300, a pumped water feed 303 delivers water into a heated vaporizer in supply box 305, which serves essentially as a temperature-controlled oven. The heated supply box 305 is required in any system where the reagents may have boiling points above room temperature, because of the possibility of condensation and accompanying changes in composition during processing. The heated supply box 305 maintained at a predetermined temperature, which maintains the feed components in the vapor phase at the set head pressure. Within the heated supply box 305, the flow of the pumped water feed 303 is in continuity with a vaporizer 310 of a known and commercially available design. The vaporizer 310 converts the water to steam. The output of the pumped water feed 303 is variably controlled and thus provides control over the mass of steam generated per unit of time in the vaporizer 310.

The heated supply box 305 may also be provided with pressure sensors 306, which interface electronically with a head pressure control valve 307 that will control the pressure within the feed system. This is required to assure maintenance of flow stability in nearby reactors while changing flow in one or more other reactors. The excess gas feed may be vented to a scrubber or other environmental control system. Alternately, or in addition, a mechanical pressure relief valve 308 may vent the system of excessive pressure in the event of a failure of the electronic pressure sensors 306 and/or head pressure control valve 307.

A plurality of mass flow controllers 315 are further provided to independently receive feed gas from gas sources 317 and regulate the throughput of other gases such as air and methane into the exemplary reaction system 300. Optionally, the inventive system may provide a purge system 320, connected to an inert gas source 322 such as a nitrogen source, to allow purging of any or all of the steam or gas pathways within the inventive reactor. The various gas pathways may also include check valves 325 to prevent backward gas flow to insure safety of use; however, the check valves 325 are not required for the operation of the reactor system.

The inventive reactor system thus provides controlled sources of steam and other reactant gases, such as methane and air. The reactant gases pass through individual conduits 330 into the heated supply box 305, where they are delivered into a distribution manifold 335 (FIG. 2 shows only a single channel of this multi-channel device), which distributes the flow into an array of a plurality of path control valves 340, or, alternately, may divert flow to a vent 345. The path control valves 340 are preferably simple solenoid valves that determine whether flow will or will not pass through a given channel. Each such path control valve 340 is paired with a flow control device 350, which may be a length of capillary, a jet, a critical orifice or a needle valve. As such, the combination of the parallel-connected channels governed by the pairs of path control valves 340 and critical orifices 350 thereby define a flow controller 352, similar to flow controller 16 (FIG. 1) defined above. While two paths with paired path control valves 340 and critical orifices 350 are shown in FIG. 2, a preferred embodiment of the present invention would have a plurality of such pairings, for example eight pairings, and the potential number of such pathways would be limited only by the physical space constraints of the reactor apparatus.

The reactant gas passes through the passive flow controllers 350, and then feeds into a gas preheat section 355, which insures that gases entering the reactors are at the appropriate temperature. The reactant gases finally enter the tube furnace 360, where the desired catalyst-reagent reaction takes place within reactor tubes 365 as described above. Again, FIG. 2 shows only one of a possible plurality of reactor tubes associated with the potential plurality of flow controllers and channels associated with the distribution manifold. The gas preheat section 355 and the tube furnace 360 are regulated by an electronic furnace temperature control 370. Temperatures in the gas preheat section 355 and the tube furnace 360 may be maintained constant through operation, or may be variable if desired as part of a given experimental design. If needed, cooling air or other gas may be instilled into the tube furnace 360 from a coolant source 365. Reactions within the reactor tubes 363 may be monitored by sensors or any separate analytical instrumentation, or the reaction may be analyzed using a plurality of continuous flow sample selection valve 375, such as a 16 port valve, which are in continuity of flow with the various reactor tubes 363. The continuous flow valve 375 allows sampling of one or more of the sixteen channels therein while simultaneously allowing the remaining channels to flow. The 16-port continuous flow valves 375 are commercially available. The effluent from the continuous flow valve 375 includes the flow from all of the channels not sampled, and goes alternately to sensors or other instrumentation for specific analysis or to waste.

An additional feature shown on the exemplary embodiment in FIG. 2 is a heated exit box 380. Chemical reactions that produce water or other semi-volatile products should have heat traced or heated exit lines so that the materials do not potentially condense or crystallize in the sampling lines and segregate to produce erroneous analytical results. Depending upon the specific application, the temperature within the heated exit box 380 and its associated sampling lines should be above the boiling point of the expected products. When included in an embodiment as in FIG. 3, the heated exit box 380 is further provided with a lower explosive limit monitor 385, as well as an independent nitrogen system purge 390. In the event of a leak, a lower explosive limit monitor 385 allows the system to automatically add nitrogen to displace ambient air within the heated exit box 380 to reduce the possibility of fire or explosion.

Inclusion or use of the lower explosive limit monitor 385 is generally case specific for explosive gases. While the function of the lower explosive limit monitor 385 is not central to the use of the inventive reactor system, it is a safety consideration that can allow for operation with hazardous or potentially hazardous gases like hydrogen or methane.

The nitrogen system purge 390 allows reactor system startup and shutdown with a potentially explosive gas in a totally inert initial atmosphere. The nitrogen system purge 390 interfaces with the heated exit box 380 through a spring-loaded valve 395. This valve 395 is normally open valve so that electrical power must be applied to close the valve. In the event of a power failure, which would render many of the system's other safety devices in operable, the valve 395 would open by default to ensure that the system is purged with nitrogen on inadvertent shutdown.

In an embodiment of the present invention such as that shown in FIG. 2, operation of the valves and temperatures would likely be controlled and monitored by a computer, with software designed to receive and interpret input from various system sensors to keep system pressures and temperatures at the desired set points. The controlling software would also have the capability to control the mass flow controllers, the safety equipment, to cycle the path control valves according to programmed values and to vary reaction temperatures. The software control would preferably also interface with the analytical instrumentation to provide a completely integrated system.

The inventive reactor system, therefore, provides the potential for simultaneous analysis of multiple variables, including the ability to determine the number of channels, as well as the temperatures and flow therethrough. One feature of this reactor system arises from its capacity for such variability; allowing catalysts to be placed in multiple tube reactors and then controlled automatically through an aging sequence or a lifetime determination, with uniform composition feed gas. Another advantage of the coupling of the individual path control with critical orifices or other passive flow control devices in the inventive system is that the gas flow through any given reactor tube is not modified by the changes in flow through other reactor tubes in the set while head pressure is held constant. An experiment could, therefore, be terminated, changed, and re-started in one of the reactor tubes independently of the adjacent reactor sites.

The inventive reactor system could also be used in an combinatorial manner to evaluate catalyst performance over a range of thermal and flow conditions within a relatively short period of time, thereby simulating large-scale, industrial continuous flow processes. For example, such large-scale, industrial continuous flow processes include heterogeneous catalysis reactions utilized in transportation and power generation applications as well as in petroleum processing.

Those skilled in the art will now see that certain modifications can be made to the invention herein disclosed with respect to the illustrated embodiments, without departing from the spirit of the instant invention. Moreover, while the invention has been described above with respect to the preferred embodiments, it will be understood that the invention is adapted to numerous rearrangements, modifications, and alterations, all such arrangements, modifications, and alterations are intended to be within the scope of the appended claims.

1. A continuous flow reaction system, comprising:
a plurality of flow controllers for receiving a feed gas having predetermined characteristics and for outputting the same feed gas, each flow controller having a plurality of flow channels operatively connected in parallel, each flow channel having a valve and a flow controller, wherein each valve has an open setting and a closed setting to open or close the respective channel to respectively receive or block a flow of the feed gas, wherein each flow controller has a predetermined flow rate, and wherein the modified feed gas has a predetermined resultant flow rate corresponding to the combination of the predetermined flow rates connected in parallel in the flow channels with the valve in the open setting;
a plurality of reactor tubes, wherein respective ones of the plurality of reactor tubes are connectable to corresponding ones of the plurality of flow controllers, wherein each reactor tube is operable for containing a predetermined reactant capable of interacting with the feed gas in a predetermined reaction to produce a resulting effluent; and
an analytical device connectable to each of the plurality of reactor tubes for receiving the respective resulting effluents, the analytical device further generating a relative evaluation of each predetermined reaction.

2. The system of claim 1, wherein each of the plurality of flow controllers has an independently variable predetermined resultant flow rate.

3. The system of claim 1, wherein the predetermined flow rate associated with each of the plurality of flow controllers is independently variable.

4. The system of claim 1, wherein each of the plurality of reaction tubes has an independently variable predetermined reaction.

5. The system of claim 1, wherein the predetermined reaction associated with each of the plurality of reaction tubes comprises a heterogeneous catalysis reaction.

6. The system of claim 1, wherein the feed gas is selected from the group consisting of air, methane, hydrocarbons, oxygenated organic compounds, nitrogen containing organic compounds, halogenated organic compounds, aromatic compounds, refined petroleum products, reducing and oxidizing gases.

7. The system of claim 1, wherein the feed gas is selected from the group consisting of hydrogen, methane, acetylene, ethene, ethane propyne, propene, propane, higher acetyleneic, unsaturated or saturated hydrocarbons, steam, carbon dioxide, carbon monoxide, oxygen, nitrogen oxides, sulfur oxides, and ammonia.

8. The system of claim 1, wherein the feed gas may be diluted with inert gases selected from the group consisting of helium, argon, and nitrogen.

9. The system of claim 1, wherein each predetermined reactant associated with each of the plurality of reactor tubes is independently variable.

10. The system of claim 1, wherein each of the predetermined reactants is selected from the group consisting of powdered, pelletized, shaped, catalysts and supported catalysts, monolithic catalyst supports with coatings consisting of elements or compounds from one or more classes of precious metals, transition metals, alkaline earth metals, alkali metals, and lanthanide metals.

11. The system of claim 1, further comprising a housing forming a chamber containing said flow controllers, the chamber having a predetermined temperature-controlled environment.

12. The system of claim 1, further comprising a housing forming a chamber containing said effluents, the chamber having a predetermined temperature-controlled environment.

13. The system of claim 1, further comprising a housing forming a chamber containing said reactor tubes, the chamber having a predetermined temperature-controlled environment.

14. The system of claim 1, further comprising a housing forming a chamber containing a resultant flow of said feed gas prior to receipt by said reactor tubes, the chamber having a predetermined temperature-controlled environment.

15. A continuous flow reaction system, comprising:
a plurality of flow controllers for receiving a feed gas having predetermined characteristics and for outputting a common feed gas, each flow controller having a plurality of flow channels operatively connected in parallel, each flow channel having a valve and a flow controller, wherein each valve has an open setting and a closed setting to open or close the respective channel to respectively receive or block a flow of the feed gas, wherein each flow controller has an independently variable predetermined resultant flow rate, and wherein the modified feed gas has a predetermined resultant flow rate corresponding to the combination of the predetermined flow rates connected in parallel in the flow channels with the valve in the open setting;
a plurality of reactor tubes, wherein respective ones of the plurality of reactor tubes are connectable to corresponding ones of the plurality of flow controllers, wherein each reactor tube is operable for containing a predetermined reactant capable of interacting with the feed gas in a predetermined reaction to produce a resulting effluent; and
an analytical device connectable to each of the plurality of reactor tubes for receiving the respective resulting effluents, the analytical device further generating a relative evaluation of each predetermined reaction.

16. The system of claim 15, wherein the predetermined reaction associated with each of the plurality of reaction tubes comprises a heterogeneous catalysis reaction.

17. The system of claim 15, wherein the feed gas is selected from the group consisting of air, methane, steam, carbon dioxide, carbon monoxide, oxygen, nitrogen oxides, sulfur oxides, and ammonia, hydrocarbons, hydrogen, acetylene, ethene, ethane propyne, propene, propane, higher acetyleneic unsaturated or saturated hydrocarbons, oxygenated organic compounds, nitrogen containing organic compounds, halogenated organic compounds, aromatic compounds, refined petroleum products, reducing and oxidizing gases.

18. The system of claim 15, wherein each of the predetermined reactants is selected from the group consisting of powdered, pelletized, shaped, catalysts and supported catalysts, monolithic catalyst supports with coatings consisting of elements or compounds from one or more classes of precious metals, transition metals, alkaline earth metals, alkali metals, and lanthanide metals.

19. The system of claim 15, wherein the predetermined reactants may be diluted by inert gases selected from the group of helium, argon, and nitrogen.

20. The system of claim 15, further comprising a housing forming a chamber containing said flow controllers, the chamber having a predetermined temperature-controlled environment.

21. The system of claim 15, further comprising a housing forming a chamber containing said effluents, the chamber having a predetermined temperature-controlled environment.

22. The system of claim 15, further comprising a housing forming a chamber containing said reactor tubes, the chamber having a predetermined temperature-controlled environment.

23. A method of conducting a chemical reaction within a continuous flow reaction system, comprising:
receiving a feed gas having predetermined characteristics into a plurality of flow controllers and outputting a modified feed gas, each flow controller having a
plurality of flow channels operatively connected in parallel, each flow channel having a valve and a flow controller, wherein each valve has an open setting and a closed setting to open or close the respective channel to respectively receive or block a flow of the feed gas, wherein each flow controller has an independently variable predetermined resultant flow rate, and wherein the modified feed gas has a predetermined resultant flow rate corresponding to the combination of the predetermined flow rates connected in parallel in the flow channels with the valve in the open setting;
connecting said plurality of flow controllers to corresponding ones of a plurality of reactor tubes, wherein each reactor tube is operable for containing a predetermined reactant capable of interacting with the feed gas in a predetermined reaction to produce a resulting effluent; and
analyzing the respective resulting effluents with an analytical device connectable to each of the plurality of reactor tubes, the analytical device further generating a relative evaluation of each predetermined reaction.

24. The method of claim 23, wherein the predetermined reaction associated with each of the plurality of reaction tubes comprises a heterogeneous catalysis reaction.

25. The method of claim 23, wherein the feed gas is selected from the group consisting of air, methane, hydrocarbons, oxygenated organic compounds, nitrogen containing organic compounds, halogenated organic compounds, aromatic compounds, refined petroleum products, reducing and oxidizing gases.

26. The method of claim 23, wherein the feed gas is further selected from the group consisting of hydrogen, methane, acetylene, ethene, ethane propyne, propene, propane, higher acetyleneic unsaturated or saturated hydrocarbons, steam, carbon dioxide, carbon monoxide, oxygen, nitrogen oxides, sulfur oxides, and ammonia.

27. The method of claim 23, wherein the feed gas may be diluted with inert gases selected from the group consisting helium, nitrogen, and argon.

28. The method of claim 23, wherein each of the predetermined reactants is selected from the group consisting of powdered, pelletized, shaped, catalysts or supported catalysts, monolithic catalyst supports with coatings consisting of elements or compounds from one or more classes of precious metals, transition metals, alkaline earth metals, alkali metals, lanthanide metals.

29. The method of claim 23, wherein said a housing forms a chamber containing said flow controllers, said effluents, and said reactor tubes, the chamber having a predetermined temperature-controlled environment.
